(19) United States
(12) Patent Application Publication
(10) Pub. No.: US 2006/0168453 A1
(43) Pub. Date: Jul. 27, 2006

(54) Method providing protection from unauthorized access to a field device used in process automation technology

(75) Inventor: Ugenio Ferreira Da Silva Neto, Biel-Benken (CH)

Correspondence Address: BACON & THOMAS, PLLC, 625 SLATERS LANE, FOURTH FLOOR, ALEXANDRIA, VA, 22314, US

(73) Assignee: Endless + Hauser Process Solutions AG, Reinach (CH)

(21) Appl. No.: 10/518,545

(22) PCT Filed: Jul. 1, 2003
(86) PCT No.: PCT/EP03/06963

§ 371 Date: Feb. 8, 2006

(30) Foreign Application Priority Data
Jul. 2, 2002 (DE) 1029704.5

(51) Int. Cl. H04L 9/00

(52) U.S. Cl. 713/182

(57) ABSTRACT

In a method for protecting against unauthorized accessing of a field device connected via a data bus with a control unit, a security program is stored in the field device. The security program executes an authorization examination, when an accessing of the field device is attempted over the data bus.

The invention relates to a method providing protection from unauthorized access to a field device used in process automation technology, as defined in the preamble of claim 1.

In process automation technology, field devices are often used for measuring various process variables (sensors), or governing controlled variables (actuators). Sensors for determining flow rate, fill level, pressure, temperature, etc. are generally known. For registering the corresponding process variables, mass or volume flow rate, fill level, pressure, temperature, etc, the sensors are arranged in the immediate vicinity of the relevant process component.

As an example of actuators, controllable valves can be mentioned, which control the flow rate of a liquid or gas in a section of pipeline.

The sensors deliver measured values, which represent the current value of the registered process variable. These measured values are forwarded on a data bus to a control unit, e.g. a PLC (programmable logic controller), a queuing or process control system PCS.

As a rule, process control occurs from the control unit, where the measured values of various field devices are evaluated and, on the basis of the evaluation, control signals are produced for the appropriate actuators. Besides the pure transmission of measured values, field devices can also transmit additional information (diagnostics, status, etc.) to the control unit. Parametering and configuring of the field devices likewise occurs over the data bus.

Signal transmission between field device and control unit can proceed in analog or digital form, known standards being Hart®, Profibus®, Foundation Fieldbus® or CAN®-Bus. In many cases, the data bus is connected with a superordinated, company network.

Between the data bus (field bus) and the company network, a controller serves as gateway. Via the company network, especially process observation, as well as process visualization and engineering, are accomplished by means of appropriate computer units.

Field bus and company network are considered part of the process control system.

Security requirements for the process control system are becoming ever stricter; hence, in many enterprises, process control systems are strictly separated from other company networks (SAP, business). In this way, unauthorized access to field devices should be avoided. Currently, efforts concerning security for process control systems are concentrated at the network level.

For preventing company-outsider attacks, so-called firewalls are used. Besides company-outside attacks, however, company-internal attacks are likewise dangerous. In the case of company-internal attacks, e.g. parameters can be changed in field devices, or the entire control strategy can be changed. This can lead to significant disruptions in production.

For this reason, programs, which enable parametering, configuring and changing of the control strategy (SCADA-systems or configuration tools) are equipped with password protection. In this case, also an authorizing of the persons who perform changes is necessary.

E.g., in the case of the Centum CS 1000 process control system of Yokogawa, critical function blocks, which e.g. run in field devices, can only be changed via the input of two passwords of different persons.

In the case of the company Endress+Hauser, a security protection via a locking is available against unauthorized changing of parameters of field devices. The person, who wishes to make the change, must enter a code at the field device, before changes become possible in the field device.

Current process control systems often work on an Ethernet basis. In such case, it is relatively easy to access the field devices directly via an appropriate configuring unit (laptop, handheld) and, during such access, change parameters and settings. Using such an auxiliary configuring unit, it is, without more, also possible to change the entire control strategy.

A control strategy can be produced e.g. with the Syscon 302 system of the firm SMAR and loaded into the field devices.

An object of the invention is to provide a method protecting against unauthorized accessing of a field device, preventing unauthorized changing of the configuration of field devices, while being cost favorable and easily executable.

The object is achieved by the method defined in claim 1.

An essential idea of the invention is the storing of a security program in the field device itself. In the case of an accessing of the field device via the data bus, the security program performs an authorization examination. In this way, a manipulation of the field device without authorization can be prevented in simple manner.

Advantageous further developments of the invention are defined in the dependent claims.

The invention will now be explained in greater detail on the basis of an example of an embodiment illustrated in the drawing.

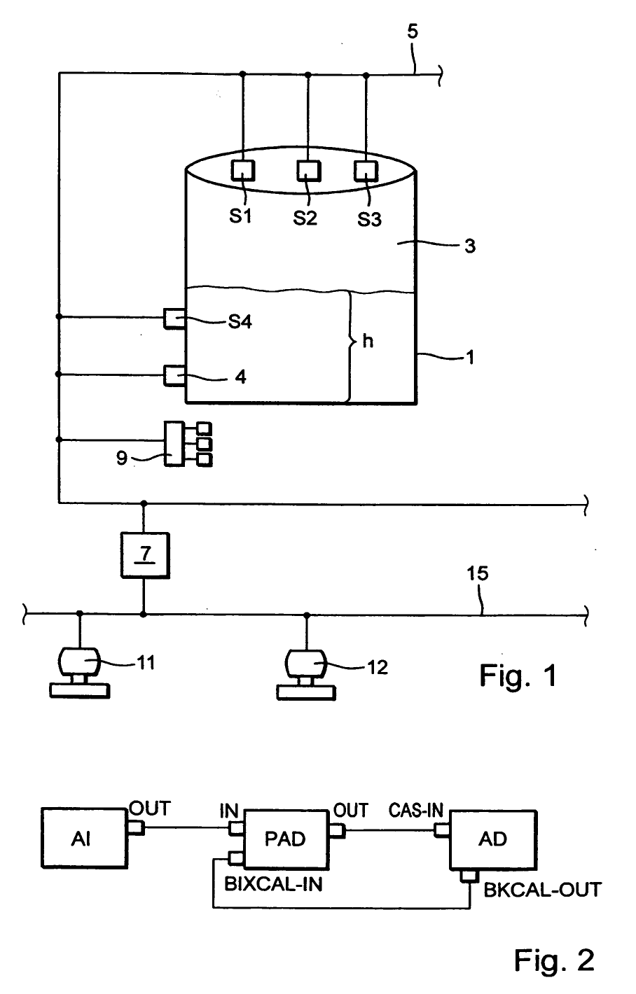

FIG. 1 shows a process control system which includes a data bus 5 and a company network 15 connected together by way of a controller 7 (linking device). Connected to the data bus 5 (field bus) are various sensors S1, S2, S3, S4, which serve for determining the fill level, height h, of a liquid in a container 1. Also arranged on container 1 is a display unit 4. Data bus 5 is, furthermore, connected with a remote I/O unit 9, which allows the connecting of various 4 to 20 mA measuring devices.

Connected to the company network 15 are various computer systems 11, 12, which provide for process visualization or serve for the engineering of the process plant.

FIG. 2 illustrates a function block, which has defined communication interfaces.

Modern data buses allow not only data transfer between a sensor and a superordinated unit, but also the performance of standardized application functions, such as are defined e.g. by the Fieldbus Foundation® or the Profibus User Organization PNO®. Function blocks possess an independent communication ability and allow the execution of complicated control procedures while interacting with different field devices.

A simple function block is a PID-controller, which communicates with a function block in a sensor and an actuator. In FIG. 2, a PID-controller function block PID is illustrated, which is connected with an analog input AI and an analog output AO. The parameters of the function blocks are set during the configuring and parametering of the field devices. They essentially determine the functionality of the field device, or the control strategy. Since the function blocks involve standardized application functions, they permit the interaction of different field devices of different manufacturers, for the execution of complex control strategies.

With the help of appropriate tools (e.g. Syscon 302), the entire control strategy, or individual parameters of function blocks, can be changed. This can, in the case of unauthorized access, lead to significant malfunctions in the process flow.

An essential aspect of the invention is the storing of a security program in the field device, which, in the case of an accessing of the field device over the data bus, performs an authorization examination. If an attempt at unauthorized access to the field device is made over the data bus, with the intent of changing parameters of function blocks stored in the field device or of replacing function blocks, this is prevented by the security examination. Only authorized persons have access to the field device.

The security program can simply be part of a function block. Alternatively, the security program can also be a part of firmware stored in the field device.

The security program includes e.g. a security key composed of a 128-bit code, or longer. The more bits the code has, the harder it is to “crack” the code. The security key can be created during installation of the field device and stored therein. Alternatively, the security key is already stored in the field device.

Only with the correct security key can changes be made in the settings of the field device, especially the function blocks.

There are, in principle, two possibilities for accessing the field device. Either a coded password is sent to the field device, which is decoded and examined with the help of the security program, or the data is sent coded to a device and the security program decodes the data, using the stored key.

For achieving a yet higher level of security, the security key is changed regularly. This can occur e.g. daily, or hourly. The shorter the intervals between the creating, plus storing, of a new security key, the more difficult undesired manipulations become.

Advantageously, the security key is stored only in the field device.

Under field devices fall not only actuators and sensors, but also controllers, PLCs and linking devices. In principle, all devices addressable over the data bus and whose settings can be changed over the data bus are included.

1-11. (canceled)

12. A method providing protection from unauthorized access to a field device connected over a data bus with a control unit, comprising the steps of:
storing in the field device a security program, which performs an authorization examination in the case of an accessing of the field device over the data bus.

13. The method as claimed in claim 12, wherein:
the security program is part of a function block.

14. The method as claimed in claim 12, wherein:
the security program is part of firmware stored in the field device.

15. The method as claimed in claim 12, wherein:
the security program includes a security key, which is stored in the field device during configuration of the field device.

16. The method as claimed in claim 12, wherein:
the security key is an at least 128-bit code.

17. The method as claimed in claim 12, wherein:
the security key is created during installation of the field device.

18. The method as claimed in claim 12, wherein:
the security key is provided by the field device.

19. The method as claimed in claim 12, wherein:
the security key is regularly renewed.

20. The method as claimed in claim 12, wherein:
the security key is renewed hourly.

21. The method as claimed in claim 12, wherein:
the security key is stored only in the field device.

22. The method as claimed in claim 12, wherein:
the field devices are sensors, actuators, controllers, PLCs or gateways.
